(19) United States
(12) Patent Application Publication
(10) Pub. No.: US 2002/0103741 A1
(43) Pub. Date: Aug. 1, 2002

(54) Centralized order book method and system

(75) Inventors: Stephen J. Boies, Mahopac, NY (US); Samuel H. Dinkin, Austin, TX (US); David P. Greene, Ossining, NY (US); William Grey, Millwood, NY (US); Paul A. Moskowitz, Yorktown Heights, NY (US); Philip S. Yu, Chappagua, NY (US)

Correspondence Address: Duke W. Yee, Carstens, Yee & Cahoon, LLP, P.O. Box 802334, Dallas, TX, 75380, US

(73) Assignee: International Business Machines Corporation, Armonk, NY (US)

(21) Appl. No.: 09/773,295

(22) Filed: Jan. 31, 2001

(51) Int. Cl. G06F 17/60

(52) U.S. Cl. 705/37; 705/26

(57) ABSTRACT

A method and system are described for creating and maintaining a centralized order book. The centralized order book is used to clear orders. Multiple orders are aggregated from a plurality of different individual marketplaces by posting the orders in the centralized order book. The centralized order book then attempts to clear at least one of the orders utilizing other ones of the orders posted in the centralized order book. The central order book and individual marketplaces are maintained within computer systems which are coupled together utilizing a network.

### CROSS-REFERENCE TO RELATED APPLICATIONS

The present invention is related to the subject matter of co-pending patent application Ser. No. ______ (Docket Number YOR9-2000-0759US1) entitled “METHOD AND SYSTEM FOR DECENTRALIZED ORDER MATCHING AMONG INDIVIDUAL MARKETPLACES”, assigned to the assignee herein named, filed on ______ and incorporated herein by reference.

### BACKGROUND OF THE INVENTION

1. Technical Field

The present invention relates in general to apparatus and methods for providing a centralized order book. More particularly, the present invention provides apparatus and methods for providing a centralized order book for clearing orders aggregated from a plurality of different individual marketplaces.

2. Description of Related Art

Individual marketplaces are known for matching and clearing orders. An individual marketplace maintains its own, local order book for clearing orders. A “marketplace” is an entity, such as an auction, which matches buyers and sellers to clear orders. A potential buyer may post a buy order in the local order book. Similarly, a potential seller may post a sell order in the local order book. The individual marketplace is then responsible for attempting to clear these orders by matching them with other orders which are posted in the local order book.

Large marketplaces have the advantage of bringing together greater numbers of buyers and sellers, thus increasing the potential to clear a large number of transactions. This reduces the operating costs of the marketplace, and thus the costs to the buyers and sellers.

In practice, however, multiple marketplaces generally exist for a given set of goods or services, often with different sets of buyers and sellers. This can limit the potential for individual marketplaces to clear a large number of orders.

Therefore, a need exists for a method and system for providing a centralized order book for clearing orders aggregated from a plurality of different individual marketplaces.

### SUMMARY OF THE INVENTION

A method and system are described for creating and maintaining a centralized order book. The centralized order book is used to clear orders. Multiple orders are aggregated from a plurality of different individual marketplaces by posting the orders in the centralized order book. The centralized order book then attempts to clear at least one of the orders utilizing other ones of the orders posted in the centralized order book. The central order book and individual marketplaces are maintained within computer systems which are coupled together utilizing a network.

The above as well as additional objectives, features, and advantages of the present invention will become apparent in the following detailed written description.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a diagram illustrating a distributed data processing system according to the present invention;

FIG. 2 is an exemplary block diagram of a server according to the present invention;

FIG. 3 is an exemplary block diagram of a client according to the present invention;

FIG. 4 illustrates a high level flow chart which depicts an individual marketplace receiving and posting an order in a centralized order book in accordance with a first embodiment of the present invention;

FIG. 5 depicts a high level flow chart which illustrates a centralized order book clearing orders in accordance with the first embodiment of the method and system of the present invention;

FIG. 6 illustrates a high level flow chart which depicts an individual marketplace receiving and posting an order in a centralized order book in accordance with a second embodiment of the present invention; and

FIG. 7 depicts a high level flow chart which illustrates a centralized order book clearing orders in accordance with the second embodiment of the method and system of the present invention.

### DETAILED DESCRIPTION OF THE PREFERRED EMBODIMENT

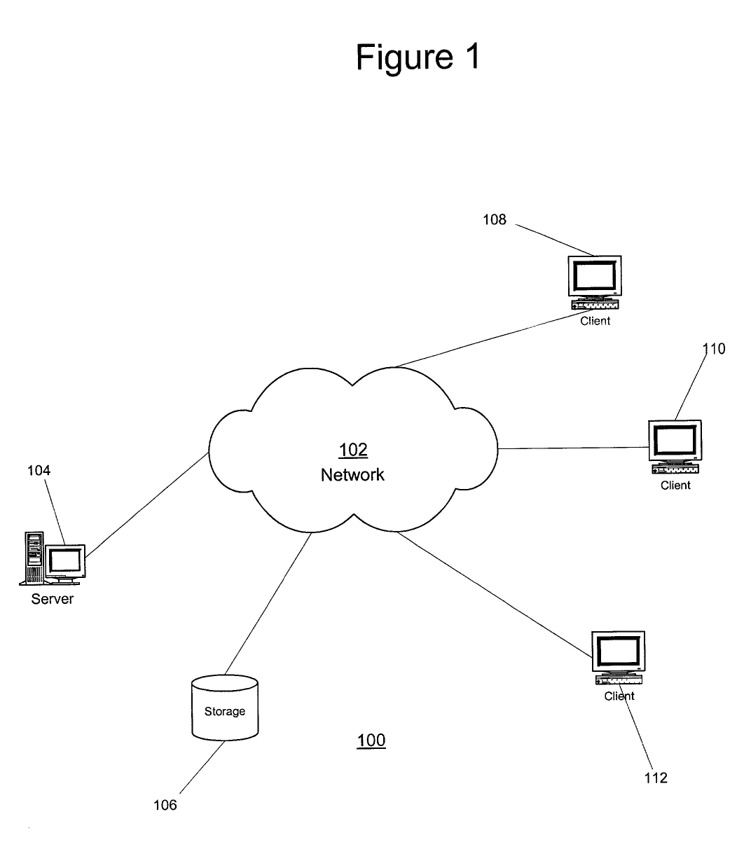

A preferred embodiment of the present invention and its advantages are better understood by referring to FIGS. 1-7 of the drawings, like numerals being used for like and corresponding parts of the accompanying drawings.

The invention is preferably realized using a well-known computing platform, such as an IBM RS/6000 workstation running the IBM AIX operating system. However, it may be realized in other popular computer system platforms, such as an IBM personal computer running the Microsoft Windows operating system or a Sun Microsystems workstation running operating systems such as UNIX or LINUX, without departing from the spirit and scope of the invention.

The present invention is a method and system for providing a centralized order book for clearing orders aggregated from a plurality of different individual marketplaces. These orders are posted in the centralized order book by the individual marketplaces. The centralized order book then attempts to clear these orders utilizing other orders posted in the centralized order book.

As an order is posted in the order book of each individual marketplace, the individual marketplace may decide to either clear the order locally using the marketplace's own, local order book, or the individual marketplace may decide to post the order in the central order book. If the individual marketplace decides to post the order in the central order book, the individual marketplace posts the order in the central order book.

The centralized order book then attempts to clear orders posted in its order book with other orders posted in the centralized order book. The centralized order book attempts to match a posted order with a “best” matching order. The centralized order book may utilize any known method for determining which order is a “best” matching order. In addition, the centralized order book and each individual marketplaces may all use the same method, or the centralized order book and each individual marketplaces may each use a different method for determining matches.

In some cases the “best” matching order is actually a combination of orders. In these cases, the “best” matching order is more than one order. For example, a buyer may post an order to buy five cars of a particular model at $20,000 each. This order may be matched with one order to sell two of this car model at $18,000 with another order to sell six of this model at $19,000. The “best” match for the buy order is two cars at $18,000 each and three cars at $19,000 each.

The order books may determine a “best” matching order using the price of an order, its queue position, the identity of the originating marketplace, and/or any other suitable criteria.

In one embodiment, after the order is posted in the central order book, the central order book may clear the order after the central order book receives permission to clear the order from the individual marketplace. In another embodiment, the central order book will lock the order in the central order book and then verify from the individual marketplace that the order is still available to be cleared prior to clearing the order.

The centralized order book may obtain a transaction fee for matching orders from the individual marketplace where these matching orders originated. The centralized order book may use any known method for obtaining a transaction fee. As one example, the centralized order book may handle the payment which the buyer paid to the seller. In this example, the centralized order book might keep a portion of this payment before transmitting the payment to the appropriate marketplace.

In the preferred embodiment, the centralized order book and the various individual marketplaces exist within computer systems which are coupled to each other using a network, such as the Internet. These marketplaces may exist within a single computer system, but are typically each implemented in different computer systems.

The individual marketplaces are entities which are capable of matching buyers and sellers. In a preferred embodiment, these marketplaces are auctions, typically Internet auction sites. The individual marketplaces may be any combination of one or more types of auctions, such as reverse auctions, multi-sided auctions, and/or call auctions.

In the preferred embodiment, each marketplace is an on-line auction site maintained on a computer system which is coupled to the Internet. Potential buyers and sellers are permitted to access the auction site and post their orders. The auction site then matches buyers and sellers in order to clear orders. The centralized order book then receives orders from various auction sites. These orders are posted in the centralized order book by the individual auction sites. The centralized order book then attempts to clear orders from its order book.

With reference now to the figures, and in particular with reference to FIG. 1, a pictorial representation of a distributed data processing system is depicted in which the present invention may be implemented. Distributed data processing system 100 is a network of computers in which the present invention may be implemented. Distributed data processing system 100 contains network 102, which is the medium used to provide communications links between various devices and computers connected within distributed data processing system 100. Network 102 may include permanent connections, such as wire or fiber optic cables, or temporary connections made through telephone connections.

In the depicted example, server 104 is connected to network 102, along with storage unit 106. In addition, clients 108, 110 and 112 are also connected to network 102. These clients, 108, 110 and 112, maybe, for example, personal computers, network computers, personal digital assistants, data network compatible cellular devices, cable or satellite TV set-top boxes, Internet ready game consoles, and the like. For purposes of this application, a network computer is any computer coupled to a network which receives a program or other application from another computer coupled to the network. In the depicted example, server 104 provides data, such as boot files, operating system images and applications, to clients 108-112. Clients 108, 110 and 112 are clients to server 104. Distributed data processing system 100 may include additional servers, clients, and other devices not shown.

In the depicted example, distributed data processing system 100 is the Internet, with network 102 representing a worldwide collection of networks and gateways that use the TCP/IP suite of protocols to communicate with one another. At the heart of the Internet is a backbone of high-speed data communication lines between major nodes or host computers consisting of thousands of commercial, government, education, and other computer systems that route data and messages. Of course, distributed data processing system 100 also may be implemented as a number of different types of networks such as, for example, an intranet or a local area network. FIG. 1 is intended as an example and not as an architectural limitation for the processes of the present invention.

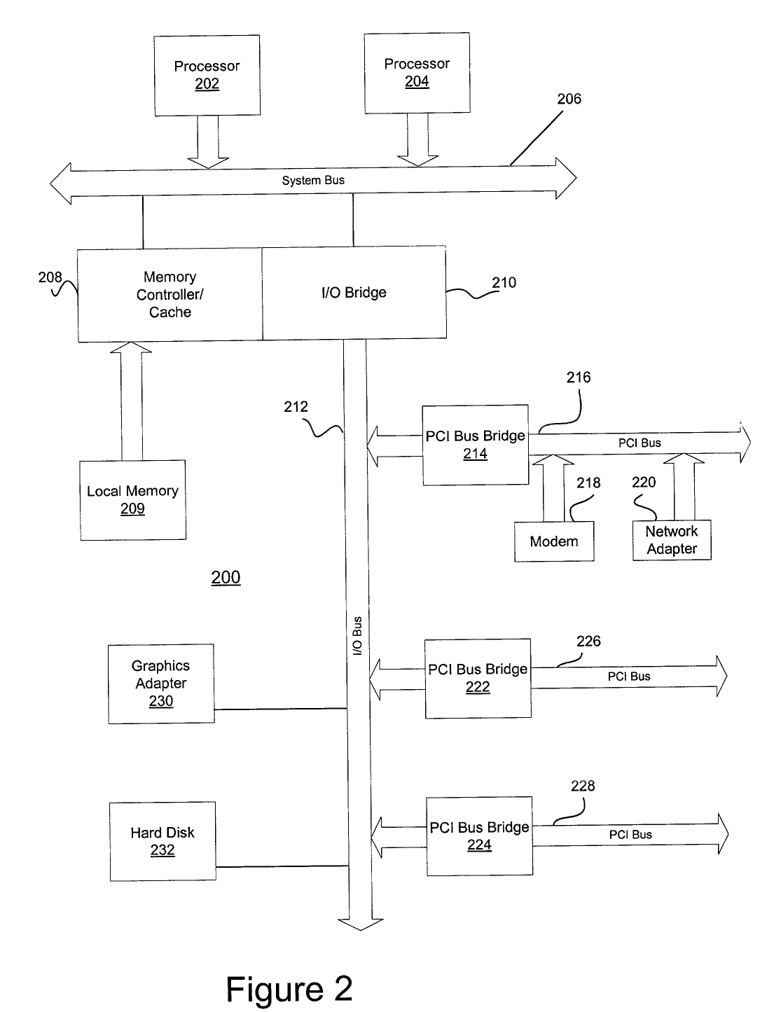

Referring to FIG. 2, a block diagram of a data processing system which may be implemented as a server, such as server 104 in FIG. 1, is depicted in accordance with the present invention. Data processing system 200 may be a symmetric multiprocessor (SMP) system including a plurality of processors 202 and 204 connected to system bus 206. Alternatively, a single processor system may be employed. Also connected to system bus 206 is memory controller/cache 208, which provides an interface to local memory 209. I/O bus bridge 210 is connected to system bus 206 and provides an interface to I/O bus 212. Memory controller/cache 208 and I/O bus bridge 210 may be integrated as depicted. Peripheral component interconnect (PCI) bus bridge 214 connected to I/O bus 212 provides an interface to PCI local bus 216. A number of modems 218-220 may be connected to PCI bus 216. Typical PCI bus implementations will support four PCI expansion slots or add-in connectors. Communications links to network computers 108-112 in FIG. 1 may be provided through modem 218 and network adapter 220 connected to PCI local bus 216 through add-in boards. Additional PCI bus bridges 222 and 224 provide interfaces for additional PCI buses 226 and 228, from which additional modems or network adapters may be supported. In this manner, server 200 allows connections to multiple network computers. A memory mapped graphics adapter 230 and hard disk 232 may also be connected to I/O bus 212 as depicted, either directly or indirectly.

Those of ordinary skill in the art will appreciate that the hardware depicted in FIG. 2 may vary. For example, other peripheral devices, such as optical disk drives and the like, also may be used in addition to or in place of the hardware depicted. The depicted example is not meant to imply architectural limitations with respect to the present invention. The data processing system depicted in FIG. 2 may be, for example, an IBM RISC/System 6000, a product of International Business Machines Corporation in Armonk, N.Y., running the Advanced Interactive Executive (AIX) operating system.

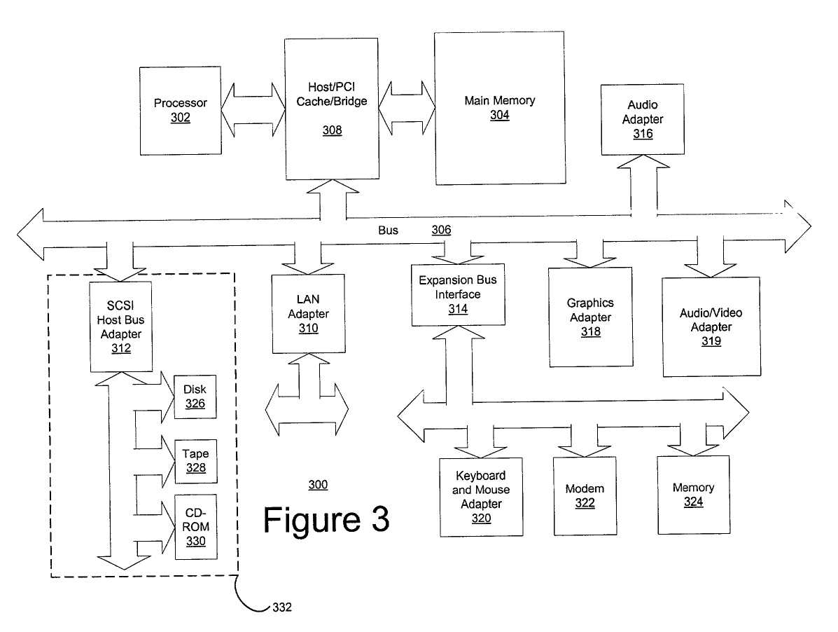

With reference now to FIG. 3, a block diagram of a data processing system in which the present invention may be implemented is illustrated. Data processing system 300 is an example of a client computer. Data processing system 300 employs a peripheral component interconnect (PCI) local bus architecture. Although the depicted example employs a PCI bus, other bus architectures, such as Micro Channel and ISA, may be used.

Processor 302 and main memory 304 are connected to PCI local bus 306 through PCI bridge 308. PCI bridge 308 may also include an integrated memory controller and cache memory for processor 302. Additional connections to PCI local bus 306 may be made through direct component interconnection or through add-in boards. In the depicted example, local area network (LAN) adapter 310, SCSI host bus adapter 312, and expansion bus interface 314 are connected to PCI local bus 306 by direct component connection.

In contrast, audio adapter 316, graphics adapter 318, and audio/video adapter (A/V) 319 are connected to PCI local bus 306 by add-in boards inserted into expansion slots. Expansion bus interface 314 provides a connection for a keyboard and mouse adapter 320, modem 322, and additional memory 324.

In the depicted example, SCSI host bus adapter 312 provides a connection for hard disk drive 326, tape drive 328, CD-ROM drive 330, and digital video disc read only memory drive (DVD-ROM) 332. Typical PCI local bus implementations will support three or four PCI expansion slots or add-in connectors.

An operating system runs on processor 302 and is used to coordinate and provide control of various components within data processing system 300 in FIG. 3. The operating system may be a commercially available operating system, such as Windows 2000, which is available from Microsoft Corporation. Windows is a trademark of Microsoft Corporation.

An object oriented programming system, such as Java, may run in conjunction with the operating system, providing calls to the operating system from Java programs or applications executing on data processing system 300. Instructions for the operating system, the object-oriented operating system, and applications or programs are located on a storage device, such as hard disk drive 326, and may be loaded into main memory 304 for execution by processor 302.

Those of ordinary skill in the art will appreciate that the hardware in FIG. 3 may vary depending on the implementation. For example, other peripheral devices, such as optical disk drives and the like, may be used in addition to or in place of the hardware depicted in FIG. 3. The depicted example is not meant to imply architectural limitations with respect to the present invention. For example, the processes of the present invention may be applied to multiprocessor data processing systems.

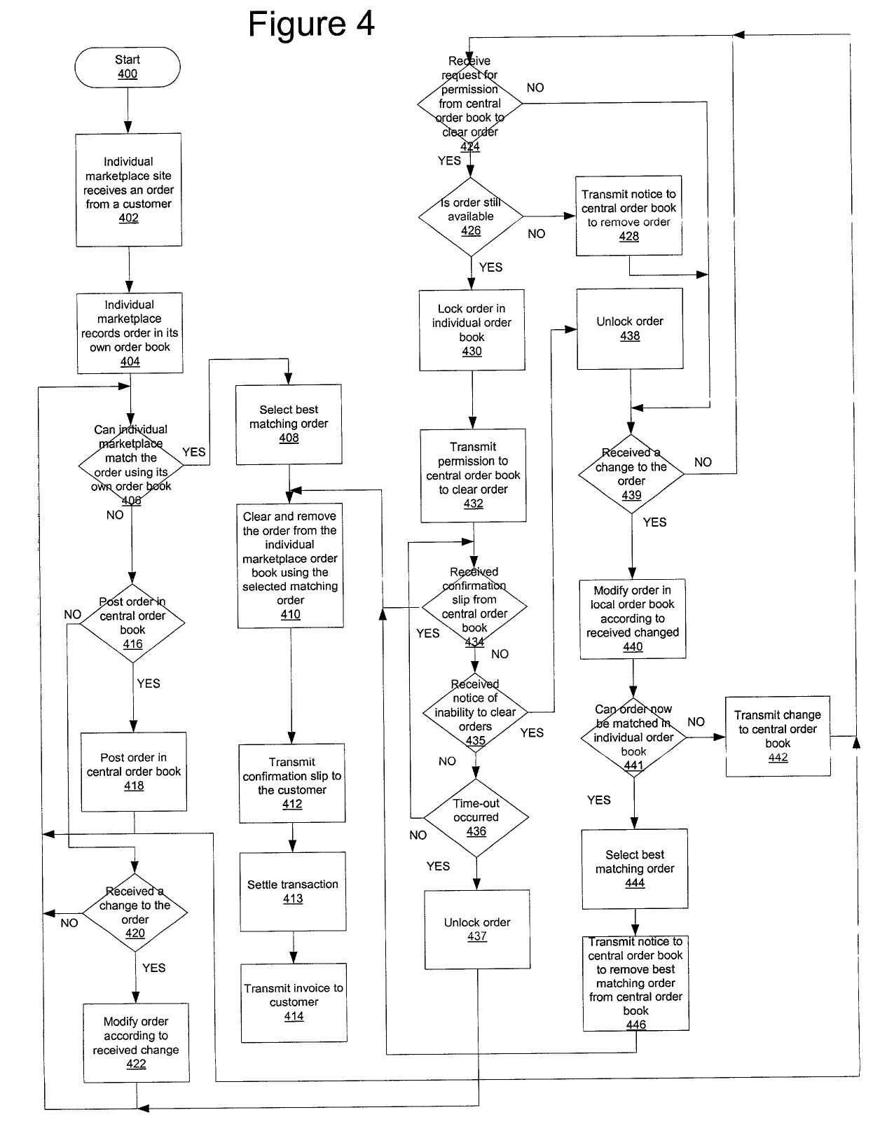

FIG. 4 illustrates a high level flow chart which depicts an individual marketplace receiving and posting an order in a centralized order book in accordance with a first embodiment of the present invention. The process starts as depicted by block 400 and thereafter passes to block 402 which illustrates an individual marketplace site receiving an order from a customer. An order may be a market order, a limit order, or a contingent order. Further, these orders may have a limited duration. The orders may include orders for immediate delivery, future delivery, or orders contingent on the occurrence of a specified event.

Next, block 404 depicts an individual marketplace recording the order in that individual marketplace's order book. The individual marketplace's order book is also referred to as the local order book. Thereafter, block 406 illustrates a determination of whether or not the individual marketplace can match the order using its own, local order book. If a determination is made that the individual marketplace can match the order using its own order book, the process passes to block 408 which depicts the individual marketplace selecting the best matching order from its own order book.

Block 410, then, illustrates the individual marketplace clearing the order and then removing it from the individual marketplace's order book. Thereafter, block 412 depicts the individual order book transmitting a confirmation slip to the customer. The process then passes to block 413 which depicts settling the transaction. When the transaction is settled, the goods and/or services and the payments for these goods/services exchange hands. Next, block 414 illustrates the individual marketplace transmitting an invoice to the customer.

Referring again to block 406, if a determination is made that the individual marketplace cannot clear the order using its own order book, the process passes to block 416 which depicts a determination of whether or not the individual marketplace wants to post the order in the central order book. In some cases the individual order book may not want to post an order in the central order book. For example, if a particularly financially attractive order is received in the individual order book, the individual order may want to keep the order for some time attempting to match the order locally, and thus making a greater profit from matching and clearing the order. In other cases, all orders which have been posted in an individual marketplace will be posted in the central order book.

In response to a determination that the individual marketplace does not want to post the order in the central order book, the process passes to block 420 which depicts a determination of whether or not a change has been received to the order. If a determination is made that no change has been received, the process passes back to block 406. Referring again to block 420, if a determination is made that a change has been received to the order, the process passes to block 422 which illustrates a modification to the order according to the received change. The process then passes back to block 406.

Referring again to block 416, if a determination is made that the individual marketplace does want to post the order in the central order book, the process passes to block 418 which illustrates posting the order in the central order book. The process then passes to both blocks 424 and 406. Both of these paths are processed concurrently.

Referring again to block 424, block 424 depicts a determination of whether or not the individual marketplace has received a request for permission from the central order book to clear the order. If a determination is made that the individual order book has not received a request from the central order book for permission to clear the order, the process passes to block 439.

Referring again to block 424, if a determination is made that the individual order book has received a request from the central order book for permission to clear the order, the process passes to block 426 which illustrates a determination of whether or not the order is still available in the local order book. If a determination is made that the order is not still available, the process passes to block 428 which depicts the individual order book transmitting a notice to the centralized order book that the order is no longer available. The process then passes to block 439.

Referring again to block 426, if a determination is made that the order is still available in the local order book, the process passes to block 430 which depicts locking the order in the local order book. Next, block 432 illustrates the individual marketplace transmitting permission to the central order book to clear the order.

Thereafter, block 434 depicts a determination of whether or not the individual marketplace has received a confirmation slip from the central order book in a timely manner. If a determination is made that the individual marketplace has not received a confirmation slip from the central order book in a timely manner, the process passes to block 435 which depicts a determination of whether or not the individual marketplace has received a notice from the central marketplace that it was unable to clear the order. If a determination is made that the individual marketplace has received a notice of an inability to clear the order, the process passes to block 438.

Referring again to block 435, if a determination is made that the individual marketplace has not received a notice of an inability to clear the order, the process passes to block 436 which illustrates a determination of whether or not a time-out has occurred. If a determination that a time-out has not occurred, the process passes to block 434.

Referring again to block 436, if a determination is made that a time-out has occurred, the process passes to block 437 which depicts unlocking the order. The process then passes to block 406.

Referring again to block 434, if a determination is made that the individual marketplace has received a confirmation slip from the central order book, the process passes to block 410.

Referring again to block 438, block 438 depicts unlocking the order. Next, block 439 illustrates a determination of whether or not the individual marketplace has received a change to the order. If a determination is made that the individual marketplace has not received a change to the order, the process passes back to block 424. Referring again to block 439, if a determination is made that the individual marketplace has received a change to the order, the process passes to block 440 which depicts the individual marketplace modifying the order in the local order book according to the received change. Next, block 441 illustrates a determination of whether or not the order can now be cleared in the local order book. If a determination is made that the order cannot now be cleared in the local order book, the process passes to block 442 which depicts the local order book transmitting the change to the order to the central order book. The process then passes to block 424.

Referring again to block 441, if a determination is made that the order can now be matched in the local order book, the process passes to block 444 which illustrates selecting a best matching order. Thereafter, block 446 depicts transmitting a notice to the central order book to clear and remove the best matching order from the central order book. The process then passes to block 410.

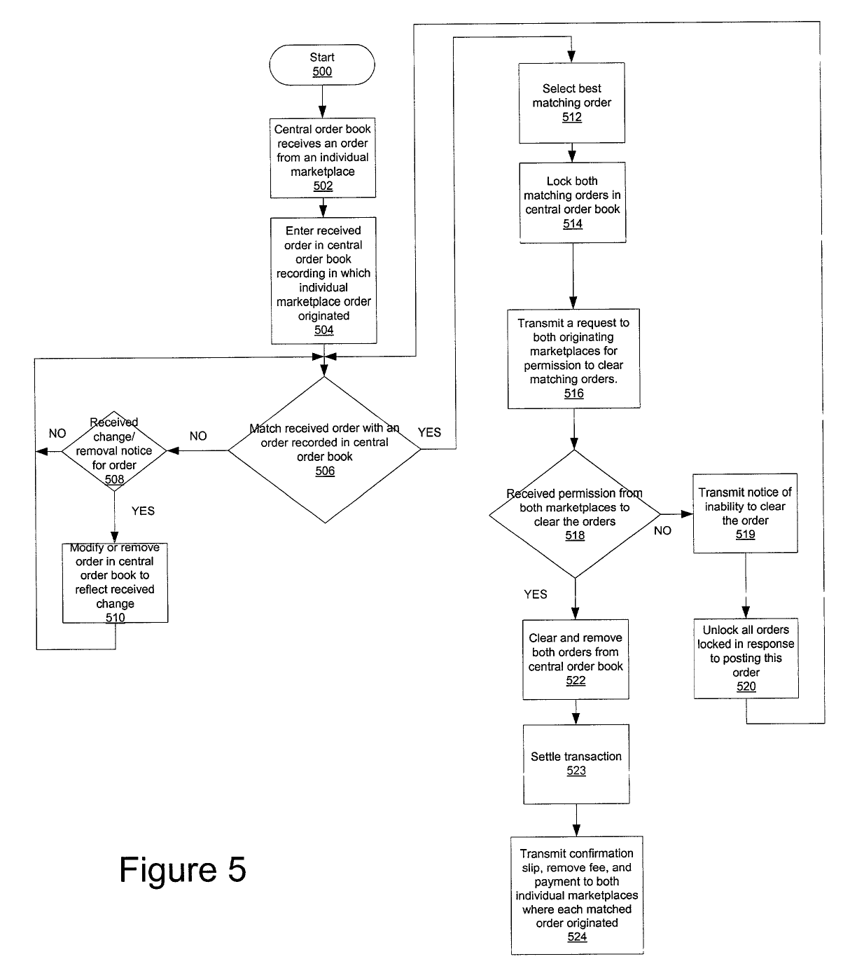

FIG. 5 depicts a high level flow chart which illustrates a centralized order book clearing orders in accordance with the first embodiment of the method and system of the present invention. The process starts as depicted by block 500 and thereafter passes to block 502 which illustrates the central order book receiving an order from an individual marketplace. Next, block 504 depicts entering the received order in the central order book and indicating in which individual marketplace the order originated. Thereafter, block 506 illustrates a determination of whether or not the central order book is able to match the received order with an existing order in its book. If a determination is made that the central order book is not able to match the received order with an existing order, the process passes to block 508 which illustrates a determination of whether or not the central order book has received a change to this order. The change to the order may be an instruction to remove the order from the central order book. If a determination is made that the central order book has not received a change to the order, the process passes back to block 506. Referring again to block 508, if a determination is made that the central order book has received a change to the order, the process passes to block 510 which depicts the central order book modifying or removing the order in accordance with the received change. The process passes back to block 506.

Referring again to block 506, if a determination is made that the central order is able to match the received order, the process passes to block 512 which illustrates the central order book selecting the best existing order which matches the received order. Next, block 514 depicts the central order locking both the received order and the selected existing order in the central order book. Thereafter, block 516 illustrates the central order book transmitting a request to both individual marketplaces where these two orders originated for permission to clear the matching orders. The process then passes to block 518 which depicts a determination of whether or not the central order book has received permission from both of the individual marketplaces to clear the order. If a determination is made that the central order book has not received permission from both of the individual marketplaces, the process passes to block 519 which depicts transmitting a notice of an inability to clear the orders to both of the individual marketplaces. Next, block 520 illustrates the central order book unlocking all orders which were locked in response to posting this received order. The process then passes back to block 506.

Referring again to block 518, if a determination is made that the central order book has received permission from both individual marketplaces, the process passes to block 522 which depicts the central order book clearing both orders from the central order book. Next, block 523 depicts settling the transaction.

Thereafter, block 524 illustrates the central order book transmitting a confirmation slip and a payment to both individual marketplaces where the matching orders originated. In addition, the central order book will remove its transaction fee from the payment made to the individual marketplaces. The transaction fee may represent a commission from a specified fee schedule. The fee may represent a spread between the bid and the offer price. The fees may be divided among the central order book and the individual order books where the matching orders originated according to a pre-specified rule or set of rules. The fees may be tracked and monitored and periodically reported back to the individual marketplaces.

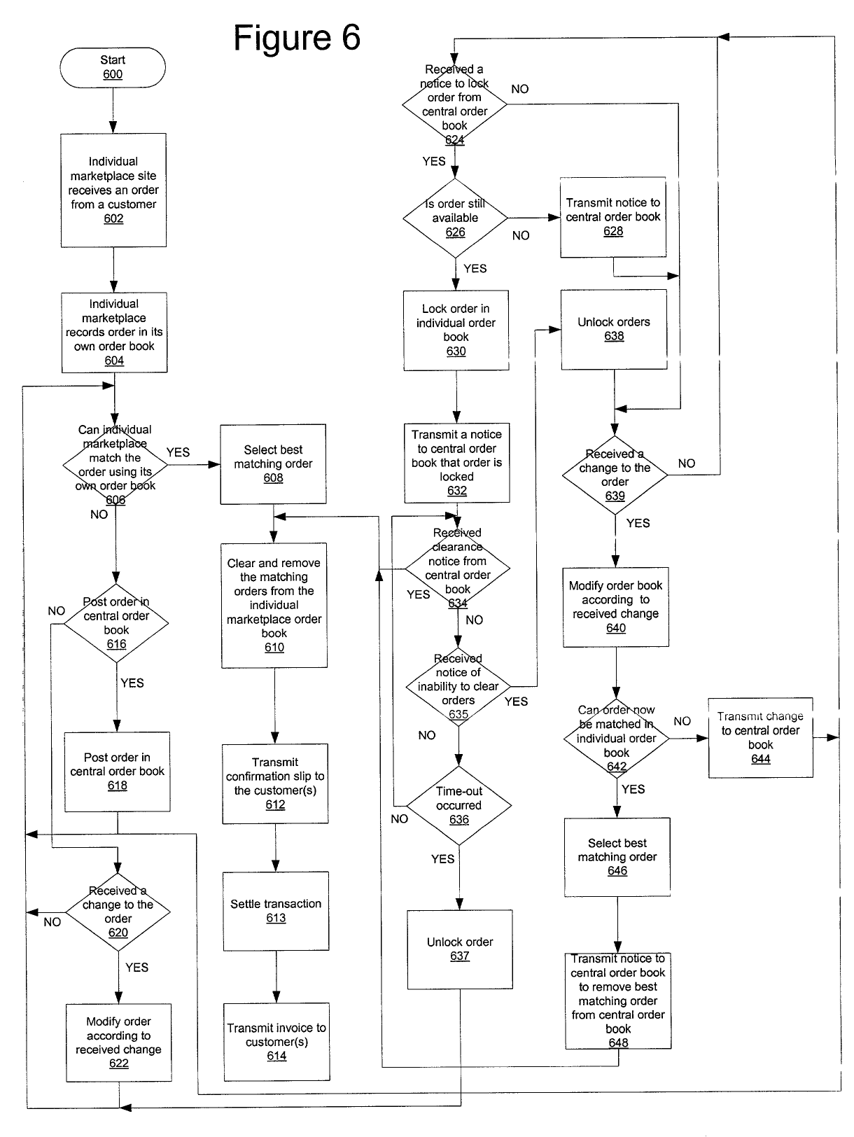

FIG. 6 illustrates a high level flow chart which depicts an individual marketplace receiving and posting an order in a centralized order book in accordance with a second embodiment of the present invention. The process starts as depicted by block 600 and thereafter passes to block 602 which illustrates an individual marketplace site receiving an order from a customer. Next, block 604 depicts an individual marketplace recording the order in that individual marketplace's order book. Thereafter, block 606 illustrates a determination of whether or not the individual marketplace can match the order using its own, local order book. If a determination is made that the individual marketplace can match the order using its own order book, the process passes to block 608 which depicts the individual marketplace selecting the best matching order from its own order book.

Block 610, then, illustrates the individual marketplace clearing the order and then removing it from the individual marketplace's order book. Thereafter, block 612 depicts the individual order book transmitting a confirmation slip to the customer. The process then passes to block 613 which illustrates settling the transaction. Next, block 614 illustrates the individual marketplace transmitting an invoice to the customer.

Referring again to block 606, if a determination is made that the individual marketplace cannot clear the order using its own order book, the process passes to block 616 which depicts a determination of whether or not the individual marketplace wants to post the order in the central order book. In response to a determination that the individual marketplace does not want to post the order in the central order book, the process passes to block 620 which depicts a determination of whether or not a change has been received to the order. If a determination is made that no change has been received, the process passes back to block 606. Referring again to block 620, if a determination is made that a change has been received to the order, the process passes to block 622 which illustrates a modification to the order according to the received change. The process then passes back to block 606.

Referring again to block 616, if a determination is made that the individual marketplace does want to post the order in the central order book, the process passes to block 618 which illustrates posting the order in the central order book. The process then passes concurrently to both blocks 606 and 624.

Block 624 depicts a determination of whether or not the individual marketplace has received a notice from the central order book to lock the order in the local order book. If a determination is made that the individual order book has not received a notice from the central order book to lock the order, the process passes to block 639.

Referring again to block 624, if a determination is made that the individual order book has received a notice from the central order book to have the local order book lock the order in the local order book, the process passes to block 626 which illustrates a determination of whether or not the order is still available in the local order book. If a determination is made that the order is not still available in the local order book, the process passes to block 628 which depicts transmitting a notice to the central order book that the order is not still available. The process then passes to block 639.

Referring again to block 626, if a determination is made that the order is still available in the local order book, the process passes to block 630 which depicts locking the order in the local order book. Next, block 632 illustrates the individual marketplace transmitting a notice to the central order book that the order has been locked. Thereafter, block 634 depicts a determination of whether or not the individual marketplace has received a confirmation slip from the central order book. If a determination is made that the individual marketplace has not received a confirmation slip from the central order book, the process passes to block 635 which illustrates a determination of whether or not the individual marketplace has received a notice of an inability to clear from the central marketplace. If a determination is made that the individual marketplace has received an inability to clear notice, the process passes to block 638.

Referring again to block 635, if a determination is made that the individual marketplace has not received a notice of an inability to clear from the central marketplace, the process passes to block 636 which depicts a determination of whether or not a time-out has occurred. If a determination is made that a time-out has not occurred, the process passes to block 634.

Referring again to block 636, if a determination is made that a time-out has occurred, the process passes to block 637 which illustrates unlocking the order. The process then passes back to block 606.

Referring again to block 634, if a determination is made that the individual marketplace has received a confirmation slip from the central order book, the process passes to block 610.

Referring again to block 638, block 638 depicts the local order book unlocking the order. Next, block 639 illustrates a determination of whether or not the individual marketplace has received a change to the order. If a determination is made that the individual marketplace has not received a change to the order, the process passes back to block 624. Referring again to block 639, if a determination is made that the individual marketplace has received a change to the order, the process passes to block 640 which depicts the individual marketplace modifying the order in the local order book according to the received change. Next, block 642 illustrates a determination of whether or not the order can now be cleared in the local order book. If a determination is made that the order cannot now be cleared in the local order book, the process passes to block 644 which depicts the local order book transmitting the change to the order to the central order book. The process then passes to block 624.

Referring again to block 642, if a determination is made that the order can now be matched in the local order book, the process passes to block 646 which illustrates selecting a best matching order. Next, block 648 depicts the local order book transmitting a notice to the central order book to clear and remove the best matching order from the central order book. The process then passes back to block 610.

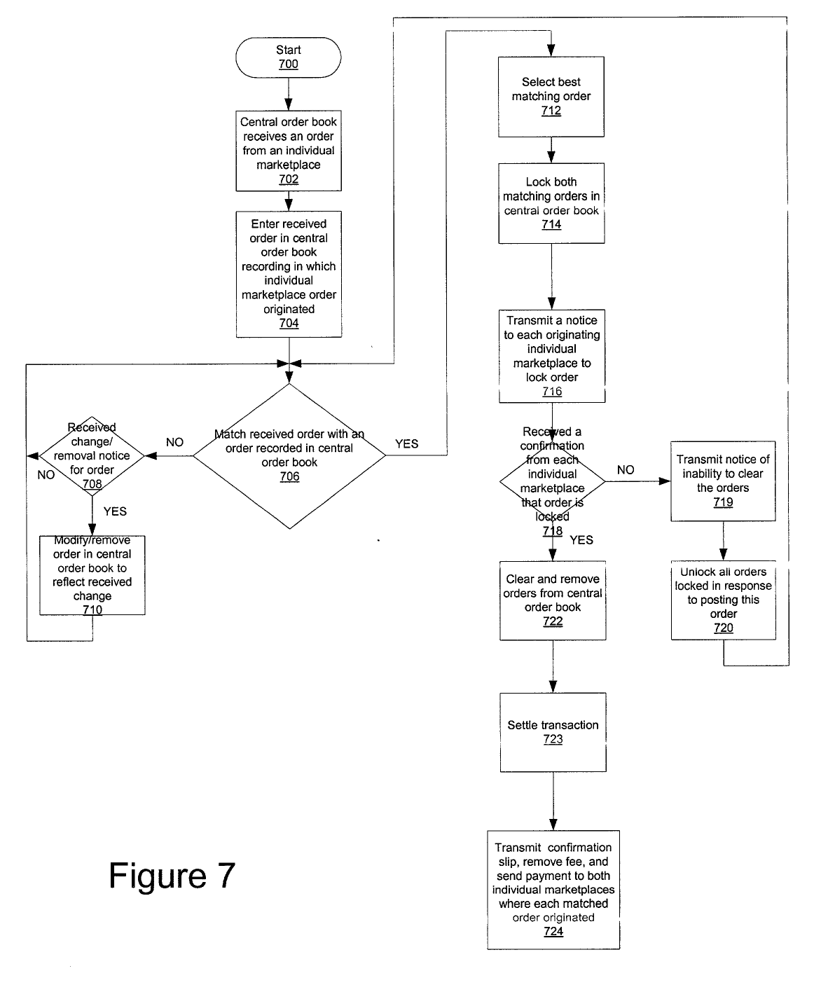

FIG. 7 depicts a high level flow chart which illustrates a centralized order book clearing orders in accordance with the second embodiment of the method and system of the present invention. The process starts as depicted by block 700 and thereafter passes to block 702 which illustrates the central order book receiving an order from an individual marketplace. Next, block 704 depicts entering the received order in the central order book and indicating in which individual marketplace the order originated. Thereafter, block 706 illustrates a determination of whether or not the central order book is able to match the received order with an existing order in its book. If a determination is made that the central order book is not able to match the received order with an existing order, the process passes to block 708 which illustrates a determination of whether or not the central order book has received a change to this order. The change to the order may be an instruction to remove the order from the central order book. If a determination is made that the central order book has not received a change to the order, the process passes back to block 706. Referring again to block 708, if a determination is made that the central order book has received a change to the order, the process passes to block 710 which depicts the central order book modifying or removing the order in accordance with the received change. The process passes back to block 706.

Referring again to block 706, if a determination is made that the central order is able to match the received order, the process passes to block 712 which illustrates the central order book selecting the best existing order(s) which matches the received order. Next, block 714 depicts the central order locking both the received order and the selected existing order in the central order book. Thereafter, block 716 illustrates the central order book transmitting a notice to each individual marketplace where these two orders originated to lock the order in their local order books. The process then passes to block 718 which depicts a determination of whether or not the central order book has received a confirmation that the order has been locked in each originating local order book. If a determination is made that the central order book has not received a notice that the orders are locked, the process passes to block 719 which depicts the central order book transmitting a notice of its inability to clear the orders to the individual order books. Next, block 720 illustrates the central order book unlocking all orders which were locked in response to posting this received order. The process then passes back to block 706.

Referring again to block 718, if a determination is made that the central order book has received notice that both orders have been locked in their originating local order books, the process passes to block 722 which depicts the central order book clearing both orders from the central order book. The process then passes to block 723 which depicts settling the transaction. Thereafter, block 724 illustrates the central order book transmitting a confirmation slip and a payment to both individual marketplaces where the matching orders originated. In addition, the central order book will remove its fee from the payment made to the individual marketplaces.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular data processing system.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method for clearing orders utilizing a centralized order book, said method comprising the steps of:
aggregating a plurality of orders from a plurality of different individual marketplaces by posting said plurality of orders in said centralized order book; and
attempting to clear at least one of said plurality of orders utilizing other ones of said plurality of orders posted in said centralized order book.

2. The method according to claim 1, further comprising the step of establishing said centralized order book in a data processing system.

3. The method according to claim 1, further comprising the step of establishing each one of said plurality of marketplaces within one of a plurality of data processing systems.

4. The method according to claim 1, further comprising the step of establishing a different local order book within each one of said plurality of marketplaces, each one of said plurality of marketplaces including a plurality of local orders which said each one of said plurality of marketplaces attempts to clear utilizing said different local order book established within said each one of said plurality of marketplaces.

5. The method according to claim 4, further comprising the step of each of said plurality of marketplaces selecting a plurality of said plurality of local orders to post in said centralized order book.

6. The method according to claim 1, further comprising the steps of:
matching one of said plurality of orders posted in said centralized order book with another one of said plurality of orders posted in said centralized order book utilizing said centralized order book; and
said centralized order book clearing said one and said another one of said plurality of orders.

7. The method according to claim 6, further comprising the steps of:
posting said one of said plurality of orders in said centralized order book utilizing a first one of said plurality of different individual marketplaces;
posting said another one of said plurality of orders in said centralized order book utilizing a second one of said plurality of different individual marketplaces; and
prior to said centralized order book clearing said one and said another one of said plurality of orders:
said centralized order book requesting permission from said first and said second ones of said plurality of different individual marketplaces; and
said centralized order book receiving permission from said first and said second ones of said plurality of different individual marketplaces.

8. The method according to claim 6, further comprising the steps of:
posting said one of said plurality of orders in said centralized order book utilizing a first one of said plurality of different individual marketplaces;
posting said another one of said plurality of orders in said centralized order book utilizing a second one of said plurality of different individual marketplaces; and
prior to said centralized order book clearing said one and said another one of said plurality of orders:
said centralized order book requesting said first one of said plurality of different individual marketplaces to lock said one of said plurality of orders in said first one of said plurality of different individual marketplace;
said centralized order book requesting said second one of said plurality of different individual marketplaces to lock said another one of said plurality of orders in said second one of said plurality of different individual marketplace; and
said centralized order book receiving notices from said first and said second ones of said plurality of different individual marketplaces.

9. The method according to claim 8, further comprising the step of said central order book obtaining a transaction fee for clearing said one and said another one of said plurality of orders.

10. The method according to claim 9, further comprising the step of said central order book obtaining a transaction fee from both said first one and said second one of said plurality of different individual marketplaces for clearing said one and said another one of said plurality of orders.

11. The method according to claim 1, where in said plurality of different individual marketplaces includes a plurality of different individual auctions.

12. The method according to claim 1, wherein said step of aggregating a plurality of orders further comprises the step of aggregating a plurality of auction bids.

13. The method according to claim 1, wherein said step of aggregating a plurality of orders further comprises the step of aggregating a plurality of reverse auction bids.

14. The method according to claim 1, wherein said step of aggregating a plurality of orders further comprises the step of aggregating a plurality of multi-sided auction bids.

15. The method according to claim 1, wherein said step of aggregating a plurality of orders further comprises the step of aggregating a plurality of call auction bids.

16. The method according to claim 1, further comprising the step of determining a best offer from said other ones of said plurality of orders posted in said centralized order book utilizing a first set of criteria.

17. The method according to claim 16, further comprising the step of determining a best offer from said other ones of said plurality of orders posted in said centralized order book utilizing a second set of criteria.

18. The method according to claim 1, further comprising the step of establishing said centralized order book in a first computer system.

19. The method according to claim 18, further comprising the step of establishing each one of said plurality of marketplaces within different computer systems.

20. The method according to claim 19, further comprising the step of coupling said first computer system to said different computer systems utilizing an Internet network.

21. A system for clearing orders utilizing a centralized order book, comprising:
a plurality of orders aggregated from a plurality of different individual marketplaces by posting said plurality of orders in said centralized order book; and
said centralized order book for attempting to clear at least one of said plurality of orders utilizing other ones of said plurality of orders posted in said centralized order book.

22. The system according to claim 21, further comprising a data processing system within which said centralized order book is established.

23. The system according to claim 21, further comprising each one of said plurality of marketplaces being established within one of a plurality of data processing systems.

24. The system according to claim 21, further comprising a different local order book being established within each one of said plurality of marketplaces, each one of said plurality of marketplaces including a plurality of local orders which said each one of said plurality of marketplaces attempts to clear utilizing said different local order book established within said each one of said plurality of marketplaces.

25. The system according to claim 24, further comprising each of said plurality of marketplaces for selecting a plurality of said plurality of local orders to post in said centralized order book.

26. The system according to claim 21, further comprising:
said centralized order book for matching one of said plurality of orders posted in said centralized order book with another one of said plurality of orders posted in said centralized order book; and
said centralized order book for clearing said one and said another one of said plurality of orders.

27. The system according to claim 26, further comprising:
a first one of said plurality of different individual marketplaces for posting said one of said plurality of orders in said centralized order book utilizing;
a second one of said plurality of different individual marketplaces for posting said another one of said plurality of orders in said centralized order book; and
prior to said centralized order book clearing said one and said another one of said plurality of orders:
said centralized order book for requesting permission from said first and said second ones of said plurality of different individual marketplaces; and
said centralized order book for receiving permission from said first and said second ones of said plurality of different individual marketplaces.

28. The system according to claim 26, further comprising:
a first one of said plurality of different individual marketplaces for posting said one of said plurality of orders in said centralized order book;
a second one of said plurality of different individual marketplaces for posting said another one of said plurality of orders in said centralized order book; and
prior to said centralized order book clearing said one and said another one of said plurality of orders:
said centralized order book for requesting said first one of said plurality of different individual marketplaces to lock said one of said plurality of orders in said first one of said plurality of different individual marketplace;
said centralized order book for requesting said second one of said plurality of different individual marketplaces to lock said another one of said plurality of orders in said second one of said plurality of different individual marketplace; and
said centralized order book for receiving notices from said first and said second ones of said plurality of different individual marketplaces.

29. The system according to claim 28, further comprising said central order book for obtaining a transaction fee for clearing said one and said another one of said plurality of orders.

30. The system according to claim 29, further comprising said central order book for obtaining a transaction fee from both said first one and said second one of said plurality of different individual marketplaces for clearing said one and said another one of said plurality of orders.

31. The system according to claim 21, wherein said plurality of different individual marketplaces includes a plurality of different individual auctions.

32. The system according to claim 21, where in said plurality of orders further comprises a plurality of auction bids.

33. The system according to claim 21, wherein said plurality of orders further comprises a plurality of reverse auction bids.

34. The system according to claim 21, wherein said plurality of orders further comprises a plurality of multi-sided auction bids.

35. The system according to claim 21, wherein said plurality of orders further comprises a plurality of call auction bids.

36. The system according to claim 21, further comprising a first set of criteria for determining a best offer from said other ones of said plurality of orders posted in said centralized order book.

37. The system according to claim 36, further comprising a second set of criteria for determining a best offer from said other ones of said plurality of orders posted in said centralized order book.

38. The system according to claim 21, further comprising said centralized order book being established in a first computer system.

39. The system according to claim 38, further comprising each one of said plurality of marketplaces being established within different computer systems.

40. The system according to claim 39, further comprising an Internet network for coupling said first computer system being coupled to said different computer systems.

41. A computer readable medium for clearing orders utilizing a centralized order book, said computer readable medium comprising:
instruction means for aggregating a plurality of orders from a plurality of different individual marketplaces by posting said plurality of orders in said centralized order book; and
instruction means for attempting to clear at least one of said plurality of orders utilizing other ones of said plurality of orders posted in said centralized order book.

42. The computer readable medium according to claim 41, further comprising instruction means for establishing said centralized order book in a data processing system.

43. The computer readable medium according to claim 41, further comprising instruction means for establishing each one of said plurality of marketplaces within one of a plurality of data processing systems.

44. The computer readable medium according to claim 41, further comprising instruction means for establishing a different local order book within each one of said plurality of marketplaces, each one of said plurality of marketplaces including a plurality of local orders which said each one of said plurality of marketplaces attempts to clear utilizing said different local order book established within said each one of said plurality of marketplaces.

45. The computer readable medium according to claim 44, further comprising instruction means for each of said plurality of marketplaces selecting a plurality of said plurality of local orders to post in said centralized order book.

46. The computer readable medium according to claim 41, further comprising:
instruction means for matching one of said plurality of orders posted in said centralized order book with another one of said plurality of orders posted in said centralized order book utilizing said centralized order book; and
instruction means for clearing said one and said another one of said plurality of orders utilizing said centralized order book.

47. The computer readable medium according to claim 46, further comprising:
instruction means for posting said one of said plurality of orders in said centralized order book utilizing a first one of said plurality of different individual marketplaces;
instruction means for posting said another one of said plurality of orders in said centralized order book utilizing a second one of said plurality of different individual marketplaces; and
instruction means for prior to said centralized order book clearing said one and said another one of said plurality of orders:
instruction means for requesting permission from said first and said second ones of said plurality of different individual marketplaces utilizing said centralized order book; and
instruction means for receiving permission from said first and said second ones of said plurality of different individual marketplaces utilizing said centralized order book.

48. The computer readable medium according to claim 46, further comprising:
instruction means for posting said one of said plurality of orders in said centralized order book utilizing a first one of said plurality of different individual marketplaces;
instruction means for posting said another one of said plurality of orders in said centralized order book utilizing a second one of said plurality of different individual marketplaces; and
instruction means for prior to said centralized order book clearing said one and said another one of said plurality of orders:
instruction means for requesting said first one of said plurality of different individual marketplaces utilizing said centralized order book to lock said one of said plurality of orders in said first one of said plurality of different individual marketplace;
instruction means for requesting said second one of said plurality of different individual marketplaces utilizing said centralized order book to lock said another one of said plurality of orders in said second one of said plurality of different individual marketplace; and
instruction means for receiving notices, utilizing said centralized order book, from said first and said second ones of said plurality of different individual marketplaces.

49. The computer readable medium according to claim 48, further comprising instruction means for obtaining a transaction fee utilizing said centralized order book for clearing said one and said another one of said plurality of orders.

50. The computer readable medium according to claim 49, further comprising instruction means for said central order book obtaining a transaction fee from both said first one and said second one of said plurality of different individual marketplaces for clearing said one and said another one of said plurality of orders.

51. The computer readable medium according to claim 41, wherein said plurality of different individual marketplaces includes a plurality of different individual auctions.

52. The computer readable medium according to claim 41, wherein said instruction means for aggregating a plurality of orders further comprises instruction means for aggregating a plurality of auction bids.

53. The computer readable medium according to claim 41, wherein said instruction means for aggregating a plurality of orders further comprises instruction means for aggregating a plurality of reverse auction bids.

54. The computer readable medium according to claim 41, wherein said instruction means for aggregating a plurality of orders further comprises instruction means for aggregating a plurality of multi-sided auction bids.

55. The computer readable medium according to claim 41, wherein said instruction means for aggregating a plurality of orders further comprises instruction means for aggregating a plurality of call auction bids.

56. The computer readable medium according to claim 41, further comprising instruction means for determining a best offer from said other ones of said plurality of orders posted in said centralized order book utilizing a first set of criteria.

57. The computer readable medium according to claim 56, further comprising instruction means for determining a best offer from said other ones of said plurality of orders posted in said centralized order book utilizing a second set of criteria.

58. The computer readable medium according to claim 41, further comprising instruction means for establishing said centralized order book in a first computer system.

59. The computer readable medium according to claim 58, further comprising instruction means for establishing each one of said plurality of marketplaces within different computer systems.

60. The computer readable medium according to claim 59, further comprising instruction means for coupling said first computer system to said different computer systems utilizing an Internet network.
